(19) United States
(12) Patent Application Publication
(10) Pub. No.: US 2008/0125503 A1
(43) Pub. Date: May 29, 2008

(54) SILICONE STABILIZERS FOR FLAME-RETARDED RIGID POLYURETHANE OR POLYISOCYANURATE FOAMS

(75) Inventors: Frauke Henning, Essen (DE); Manfred Klincke, Castrop-Rauxel (DE); Carsten Schiller, Muelheim an der Ruhr (DE)

Correspondence Address: FROMMER LAWRENCE & HAUG, 745 FIFTH AVENUE- 10TH FL., NEW YORK, NY, 10151, US

(73) Assignee: Goldschmidt GmbH, Essen (DE)

(21) Appl. No.: 11/771,496

(22) Filed: Jun. 29, 2007

(30) Foreign Application Priority Data
Jul. 1, 2006 (DE) 10 2006 030 531.0

(51) Int. Cl. C08L 75/04; C08J 9/00; C08G 77/00

(52) U.S. Cl. 521/106; 521/137; 528/10

(57) ABSTRACT

The invention relates to a process for producing rigid polyurethane or polyisocyanurate foams by reacting an isocyanate with a polyol in the presence of urethane and/or isocyanurate catalysts, water, optionally further blowing agents, optionally flame retardants and optionally further additives (e.g. fillers, emulsifiers, purely organic stabilizers and surfactants, viscosity reducers, dyes, antioxidants, UV stabilizers, antistatics) using foam stabilizers of the general formula (I) R—Si(CH₃)₂—O—[—Si(CH₃)₂—O—]ₙ—[—Si(CH₃)(R)—O—]ₘ—Si(CH₃)₂—R, where R=—(CH₂)ₓ—O—(CH₂—CHR′—O)_{y}—R″.

This application claims benefit under 35 U.S.C. 119(a) of German patent application DE 10 2006 030 531.0, filed on 1 Jul. 2006.

Any foregoing applications including German patent application DE 10 2006 030 531.0, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to the development of rigid polyurethane or polyisocyanurate foams which offer particularly advantageous use properties such as low thermal conductivity and good surface quality and also the formulations on which they are based.

In the production of rigid polyurethane and polyisocyanurate foams, use is made of cell-stabilizing additives which ensure a fine-celled, uniform foam structure which is low in defects and thus have a significant positive influence on the use properties, in particular the thermal insulation capability, of the rigid foam. Surfactants based on polyether-modified siloxanes are particularly effective and therefore represent the preferred type of foam stabilizers.

Since there are many different rigid foam formulations for various applications in which the foam stabilizer has to meet individual requirements, polyether siloxanes having different structures are used. One of the selection criteria for the foam stabilizer is the blowing agent present in the rigid foam formulation.

Various publications relating to polyether siloxane foam stabilizers for rigid foam applications have been published in the past. EP 0 570 174 B1 (U.S. Pat. No. 5,169,872) describes a polyether siloxane having the structure (CH₃)₃SiO[SiO(CH₃)₂]X[SiO(CH₃)R]_{y}Si(CH₃)₃, whose radicals R comprise a polyethylene oxide linked to the siloxane via an SiC bond and is end-capped by a C₁-C₆-acyl group at the other end of the chain. This foam stabilizer is suitable for producing rigid polyurethane foams using organic blowing agents, in particular chlorofluorocarbons such as CFC-11.

The next generation of chlorofluorocarbon blowing agents are hydrochlorofluorocarbons such as HCFC-123. When these blowing agents are used for producing rigid polyurethane foam, polyether siloxanes of the structure type (CH₃)₃SiO[SiO(CH₃)₂]ₓ[SiO(CH₃)R]_{y}Si(CH₃)₃ are suitable according to EP 0 533 202 A1 (CA 2078580). The radicals R here comprise SiC-bonded polyalkylene oxides which are composed of propylene oxide and ethylene oxide and can have a hydroxy, methoxy or acyloxy function at the end of the chain. The minimum proportion of ethylene oxide in the polyether is 25 percent by mass.

EP 0 877 045 B1 (U.S. Pat. No. 5,883,142) describes analogous structures which differ from the first-named foam stabilizers in that they have a comparatively high molecular weight and have a combination of two polyether substituents on the siloxane chain for this production process.

In the production of rigid polyurethane foams using pure fluorinated hydrocarbons such as Freon as blowing agents, it is also possible, according to EP 0 293 125 B1 (U.S. Pat. No. 4,751,251), to use mixtures of different stabilizers, for example the combination of a pure organic surfactant with a polyether siloxane.

A relatively recent development in the production of rigid polyurethane foams is to dispense with halogenated hydrocarbons as blowing agents entirely and instead to use hydrocarbons such as pentane. Thus, EP 1 544 235 (U.S. Pat. No. 7,183,330) describes the production of rigid polyurethane foams using hydrocarbon blowing agents and polyether siloxanes of the known structure (CH₃)₃SiO[SiO(CH₃)₂]ₓ[SiO(CH₃)R]_{y}Si(CH₃)₃ having a minimum chain length of the siloxane of 60 monomer units and different polyether substituents R whose mixture molecular weight is from 450 to 1000 g/mol and whose proportion of ethylene oxide is from 70 to 100 mol %.

However, the foam stabilizers described in these documents do not cover the full range of the various types of rigid foam. Improvements in the foam stabilizers compared to the prior art are desirable in many applications in order to achieve further optimization of the use properties of the rigid foams, in particular in respect of thermal conductivity, the foam defects at the surface and the burning behavior of the foams.

An important application of rigid polyurethane or polyisocyanurate foams is insulating boards having flexible covering layers (e.g. aluminum-coated paper), which are used for thermal insulation in the construction of houses and buildings. In addition, there are also composite elements which comprise a rigid foam core and solid metallic covering layers (e.g. steel sheet) and can likewise be used as construction elements in the building sector.

Both applications come within the field of building materials for which there are legal requirements in respect of fire protection. The classification concepts used here for describing the burning behavior of building materials and components are based on series of standards such as DIN 4102 or DIN EN 13501-1.

The burning tests defined therein make it possible to put fire protection terms on a concrete basis and classify building materials into various burning classes. Thus, building materials can, according to DIN 4102, be assigned to the classes A (noncombustible) and B (combustible) with the subclasses B1 (low flammability), B2 (moderately flammable) or B3 (highly flammable) if they pass the respective burning tests.

Insulation boards having a flexible or metallic covering layer thus conform to the burning class B2 if they satisfy the test criteria of the small burner test described in DIN 4102, while they have to survive the Brandschacht test for classification in class B1.

To achieve class B2, it is generally necessary to make rigid polyurethane or polyisocyanurate foam flame resistant by addition of flame retardants. Particularly useful flame retardants for rigid foams are liquid organic phosphates and phosphonates, e.g. tris(1-chloro-2-propyl)phosphate (TCPP), triethyl phosphate (TEP), diethyl ethanephosphonate (DEEP) or dimethyl propanephosphonate (DMPP). However, these flame retardants have, particularly at high contents, an adverse effect on the physical properties of the foam, in particular on the thermal conductivity and the compressive strength.

It is thus an object of the invention to achieve the required burning properties by using very small amounts of flame retardant which minimize the amount of flame retardant necessary while maintaining foam with desired properties.

Surprisingly, the foam stabilizer, too, has a significant influence on the burning behavior. If the stabilizer is varied while maintaining a constant proportion of flame retardant in a formulation, the flame heights in the small burner test in accordance with DIN 4102 can differ by a number of centimeters. Correspondingly, different amounts of flame retardant are required to attain a particular burning class depending on the stabilizer used. Burkhart, G., et al., Proceedings of the UTECH 1996 Conference, Paper 58, describe the development of silicone foam stabilizers by means of which good results in the test according to DIN 4102 can be achieved.

Typical representatives of silicone foam stabilizers having a positive influence on the burning behavior are, for example, DC 193 from Air Products or Tegostab® B 8450 and Tegostab® B 8486 from Goldschmidt GmbH.

The use of these products for producing flame-resistant rigid foam is known to those of ordinary skill in the art.

However, these products which have been optimized in respect of the burning behavior are inferior to the classical silicone foam stabilizers in respect of their action as foam stabilizer, i.e. the thermal conductivity of the rigid foam displays higher values than when using the classical products and an increased level of foam defects such as voids or densified regions on the foam surface occurs under critical conditions, for example when foam is applied to surface-coated metal sheets.

In the production of rigid foams which conform to a particular burning class, it is possible to choose between two alternatives: either to use a classical, highly active foam stabilizer and then require a higher content of flame retardants, which apart from a commercial disadvantage leads to some deterioration of the desired foam properties, or to choose a stabilizer which is optimized in respect of the burning behavior but has a lower activity and thus once again does not make optimal foam properties possible.

It was an object of the invention to develop rigid polyurethane or polyisocyanurate foams which offer particularly advantageous use properties such as low thermal conductivity and good surface quality and also the formulations on which they are based. Furthermore, it was an object to develop flame-resistant rigid polyurethane or polyisocyanurate foams which attain a required burning class (e.g. B2) using a comparatively small amount of flame retardant. The particular focus was on the combination of good use properties and flame protection in a rigid polyurethane or polyisocyanurate foam.

A further object was to develop rigid polyurethane or polyisocyanurate foam composite elements, in particular in combination with metallic materials, which offer satisfactory flame protection and at the same time advantageous use properties such as low thermal conductivity and good surface quality.

It has now surprisingly been found that polyether siloxane foam stabilizers of a particular structural type whose significant feature is α,ω-substitution (=polyether substituents at the end of the siloxane chain) not only combine these contradictory performance targets of high activity and the promotion of flame-retardant properties but even display a unexpectedly superior effect in combination with selected flame retardants.

The invention accordingly provides a process for producing rigid polyurethane or polyisocyanurate foams by reacting an isocyanate with a polyol in the presence of foam stabilizers, urethane and/or isocyanurate catalysts, water, optionally further blowing agents, optionally flame retardants and optionally further additives, (e.g. fillers, emulsifiers, purely organic stabilizers and surfactants, viscosity reducers, dyes, antioxidants, UV stabilizers, antistatics), wherein one or more compounds of the general formula (I)

R—Si(CH₃)₂—O—[—Si(CH₃)₂—O—]ₙ—[—Si(CH₃)(R¹)—O—]ₘ—Si(CH₃)₂—R²

where the substituents and indices have the following meanings:

### R, R¹, R² are identical or different and are each —(CH₂)ₓ—O—(CH₂—CHR′—O)_{y}—R″,

n+m+2=10 to 45, preferably from 10 to 40,
m=0 to 4, preferably from 0 to 2,
x=3 to 10, preferably 3,
y=1 to 19, preferably from 5 to 19,
R′═H, —CH₃, —CH₂CH₃, phenyl, preferably with at least 50% of the radicals R′═H, particularly preferably with at least 90% of the radicals R′═H,
R″═H, alkyl, acyl, preferably H, CH₃, COCH₃, particularly preferably R″═H,
   are used as foam stabilizers.

For the purposes of the present invention, it is important that polyether substituents are present at both ends of the siloxane chain (α,ω-substitution) of the polyether siloxane foam stabilizers according to the invention. In addition, a limited number of polyether substituents can be present on the silicon atoms in the interior of the siloxane chain.

The invention further provides for the use of the compounds as foam stabilizers in formulations for producing rigid polyurethane or polyisocyanurate foams.

The invention further provides foamable formulations for producing rigid polyurethane or polyisocyanurate foams by reacting an isocyanate with a polyol in the presence of foam stabilizers, urethane and/or isocyanurate catalysts, water, phosphorus-containing flame retardants, optionally further blowing agents and optionally further additives, wherein one or more compounds of the general formula (I) are used as foam stabilizers.

The invention further provides for the use of the foamable formulations for producing flame-resistant rigid polyurethane or polyisocyanurate foams.

The invention further provides for the use of the foamable formulations for producing flame-resistant rigid polyurethane or polyisocyanurate foam composites.

When the foam stabilizers according to the invention are compared with analogous polyether siloxanes without α,ω-substitution (same length of the siloxane chain, same number of polyether substituents and same type of polyethers but with the polyether substituents exclusively on silicon atoms in the interior of the siloxane chain), the stabilizers according to the invention display provide advantages in respect of thermal conductivity and surface quality of the rigid foams obtained using them.

Furthermore, the polyether siloxanes according to the invention improve the system solubility (=solubility of polyol formulation, catalysts, the polyether siloxane and the blowing agent) compared to analogous polyether siloxanes without α,ω-substitution.

The use of the α,ω-substitution makes it possible to obtain foam stabilizers for flame-resistant rigid foams which offer a better combination of the properties in respect of burning behavior and cell stabilization, i.e. which do not offer either only good burning behavior or only a high activity but combine the two properties with one another, compared to the prior art.

The stabilizers according to the invention can be used in the customary formulations for producing rigid polyurethane or polyisocyanurate foams comprising one or more organic isocyanates having two or more isocyanate functions, one or more polyols having two or more groups which are reactive toward isocyanate, catalysts for the isocyanate-polyol and/or isocyanate-water and/or isocyanate trimerization reactions, polyether siloxane foam stabilizers having a structure specified in more detail below, water, optionally physical blowing agents, optionally flame retardants and optionally further additives.

Isocyanates which are suitable for the purposes of the present invention are all polyfunctional organic isocyanates, for example diphenylmethane 4,4′-diisocyanate (MDI), tolylene diisocyanate (TDI), hexamethylene diisocyanate (HMDI) and isophorone diisocyanate (IPDI). The mixture of MDI and more highly condensed analogues having a mean functionality of from 2 to 4 which is known as “polymeric MDI” (“crude MDI”) is particularly useful.

Polyols which are suitable for the purposes of the present invention are all organic substances having a plurality of groups which are reactive toward isocyanates and also preparations thereof. Preferred polyols are all polyether polyols and polyester polyols which are customarily used for producing rigid foams. Polyether polyols are obtained by reacting polyfunctional alcohols or amines with alkylene oxides. Polyester polyols are based on esters of polybasic carboxylic acids (usually phthalic acid or terephthalic acid) with polyhydric alcohols (usually glycols).

A suitable ratio of isocyanate and polyol, expressed as the index of the formulation, is in the range from 80 to 500, preferably from 100 to 350.

Catalysts which are suitable for the purposes of the present invention are substances which catalyze the gelling reaction (isocyanate-polyol), the blowing reaction (isocyanate-water) or the dimerization or trimerization of the isocyanate. Typical examples are the amines triethylamine, dimethylcyclohexylamine, tetramethylethylenediamine, tetramethylhexanediamine, pentamethyldiethylenetriamine, pentamethyldipropylene-triamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl)ether, tin compounds such as dibutyltin dilaurate and potassium salts such as potassium acetate and potassium 2-ethylhexanoate.

Suitable amounts used depend on the type of catalyst and are usually in the range from 0.05 to 5 pphp (=parts by weight per 100 parts by weight of polyol) or from 0.1 to 10 pphp for potassium salts.

The polyether siloxane foam stabilizers of the general formula (I)

R—Si(CH₃)₂—O—[—Si(CH₃)₂—O—]ₙ—[—Si(CH₃)(R¹)—O—]ₘ—Si(CH₃)₂—R²

where R, R¹, R² are identical or different and are each —(CH₂)ₓ—O—(CH₂—CHR′—O)_{y}—R″,
which are used according to the invention are copolymers which, as a result of their preparation, are polydisperse compounds so that only mean values of the parameters n, m, x and y can be given.

The polyether siloxanes according to the invention have a mean siloxane chain length of n+m+2=10 to 45, preferably from 10 to 40, a number of internal polyether substituents of m=0 to 4, preferably from 0 to 2, and polyether substituents comprising a “linker” in the form of x=3 to 10 methylene groups (preferably 3) and a number of y=1 to 19, preferably from 5 to 19, of alkylene oxide units.

These alkylene oxide units are ethylene oxide, optionally propylene oxide, optionally butylene oxide and optionally styrene oxide in any sequence, with the mole fraction of ethylene oxide preferably being at least 50%, particularly preferably at least 90%. The end group of the polyethers is either a free OH group, an alkyl ether group (preferably methyl) or an ester formed by esterification of the OH group with any desired carboxylic acid (preferably acetic acid). Particular preference is given to polyethers having a free OH function.

The polyethers in a molecule can be identical or different as long as all components of the polyether mixture conform to the above definition. Furthermore, mixtures of various polyether siloxanes are also included as long as either the mean values of the mixture come within the abovementioned ranges or a component corresponds to the above definition.

The amounts of polyether siloxane foam stabilizers which can be used range from 0.5 to 5 pphp, preferably from 1 to 3 pphp.

Water contents which are suitable for the purposes of the present invention depend on whether or not physical blowing agents are used in addition to water. In the case of purely water-blown foams, the values are typically in the range from 1 to 20 pphp, but if other blowing agents are additionally used, the amount of water used is usually reduced to from 0.1 to 5 pphp.

Physical blowing agents which are suitable for the purposes of the present invention are gases, for example liquefied CO₂, and volatile liquids, for example hydrocarbons having from 4 to 5 carbon atoms, preferably cyclopentane, isopentane and n-pentane, fluorinated hydrocarbons, preferably HFC 245fa, HFC 134a and HFC 365mfc, chlorofluorocarbons, preferably HCFC 141b, oxygen-containing compounds such as methyl formate and dimethoxymethane or chlorinated hydrocarbons, preferably 1,2-dichloroethane.

Apart from water and, if appropriate, physical blowing agents, it is also possible to use other chemical blowing agents which react with isocyanates to evolve a gas, for example formic acid.

Flame retardants which are suitable for the purposes of the present invention are preferably liquid organic phosphorus compounds such as halogen-free organic phosphates, e.g. triethyl phosphate (TEP), halogenated phosphates, e.g. tris(1-chloro-2-propyl)phosphate (TCPP) and tris(2-chloroethyl)phosphate (TCEP), and organic phosphonates, e.g. dimethyl methanephosphonate (DMMP), dimethyl propanephosphonate (DMPP), or solids such as ammonium polyphosphate (APP) and red phosphorus. Furthermore, halogenated compounds, for example halogenated polyols, and also solids such as expandable graphite and melamine are also suitable as flame retardants.

A typical rigid polyurethane or polyisocyanurate foam formulation according to the present invention would give a foam density of from 20 to 50 kg/m³, preferably 35 to 45 kg/m³ and would have the following composition:

TABLE 1

| | Proportion |
|---|---|
| Component | by weight |
| Polyol | 100 |
| Amine catalyst | 0.05 to 5 |
| Potassium trimerization | 0 to 10 |
| catalyst | |
| Polyether siloxane | 0.5 to 5 |
| Water | 0.1 to 20 |
| Blowing agent | 0 to 40 |
| Flame retardant | 0 to 50 |
| Isocyanate index: from 80 to | |
| 500 | |

The processing of the formulations of the invention to produce rigid foams can be carried out by all methods with which those skilled in the art are familiar, for example in manual mixing processes or preferably by means of high-pressure foaming machines. In the case of metal composite elements, production can be carried out either batchwise or continuously in the double belt process.

The usual method of preparing the polyether siloxane foam stabilizers according to the invention comprises hydrosilylating olefinically unsaturated polyethers by means of SiH-functional siloxanes in the presence of transition metal catalysts and is known prior art.

### EXAMPLE

### Polyether Siloxane I (PES I)

In a 500 ml four-necked flask provided with a precision glass stirrer, reflux condenser and internal thermometer, 243.4 g of an allylpolyoxyalkylenol having a mean molecular weight of 644 g/mol and a proportion of propylene oxide of 8% together with 100 g of an α,ω-dimethylhydrogenpoly(methylhydrogen)dimethylsiloxane copolymer having a hydrogen content of 2.7 eq/kg are heated to 70° C. while stirring. 5 ppm of a platinum catalyst (Karstedt catalyst) are added. The conversion determined by measuring the volume of gas is quantitative after two hours.

### EXAMPLE

### PES II

In a 500 ml four-necked flask provided with a precision glass stirrer, reflux condenser and internal thermometer, 198.4 g of an allylpolyoxyalkylenol having a mean molecular weight of 644 g/mol and a proportion of propylene oxide of 8% together with 100 g of an α,ω-dimethylhydrogenpoly(methylhydrogen)-dimethylsiloxane copolymer having a hydrogen content of 2.2 eq/kg are heated to 70° C. while stirring. 5 ppm of a platinum catalyst (Karstedt catalyst) are added. The conversion determined by measuring the volume of gas is quantitative after two hours.

### EXAMPLE

### PES III

In a 500 ml four-necked flask provided with a precision glass stirrer, reflux condenser and internal thermometer, 148.5 g of an allylpolyoxyalkylenol having a mean molecular weight of 663 g/mol and a proportion of propylene oxide of 18% together with 100 g of an α,ω-dimethylhydrogenpoly(methylhydrogen)-dimethylsiloxane copolymer having a hydrogen content of 1.6 eq/kg are heated to 70° C. while stirring. 5 ppm of a platinum catalyst (Karstedt catalyst) are added. The conversion determined by measuring the volume of gas is quantitative after two hours.

### COMPARATIVE EXAMPLE (NOT ACCORDING TO THE INVENTION)

### PES IV

In a 500 ml four-necked flask provided with a precision glass stirrer, reflux condenser and internal thermometer, 148.5 g of an allylpolyoxyalkylenol having a mean molecular weight of 663 g/mol and a proportion of propylene oxide of 18% together with 100 g of a poly(methylhydrogen)dimethylsiloxane copolymer having a hydrogen content of 1.6 eq/kg are heated to 70° C. while stirring. 5 ppm of a platinum catalyst (Karstedt catalyst) are added. The conversion determined by measuring the volume of gas is quantitative after two hours.

### BRIEF DESCRIPTION OF THE DRAWING

FIG. 1 shows an experiment in which one part of a surface coating leveling additive was added to the formulation C and this mixture was foamed using the stabilizer DC 193 which is not according to the invention and also using the stabilizer PES II according to the invention. The high stabilization potential of the structure according to the invention is shown in a foam without defects, while severe foam defects indicate a high sensitivity to antifoams when DC 193 is used.

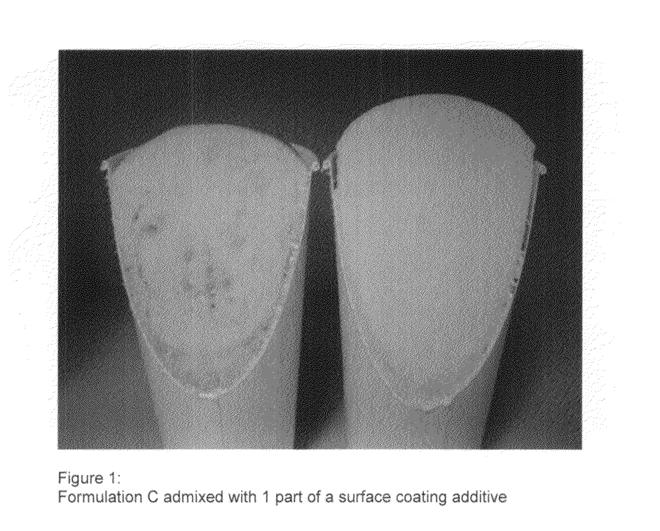

The use advantages compared to the prior art which allow the use of the foam stabilizers according to the invention in rigid foam formulations are demonstrated below with the aid of use examples. The invention is further described by the following non-limiting examples which further illustrate the invention, and are not intended, nor should they be interpreted to, limit the scope of the invention.

### USE EXAMPLES

The comparative foaming experiments were carried out by a manual mixing process. For this purpose, polyol, flame retardants, catalysts, water, conventional foam stabilizer or foam stabilizer according to the invention and blowing agent were weighed into a beaker and mixed by means of a disk stirrer (6 cm diameter) at 1000 rpm for 30 seconds. After weighing again, the amount of blowing agent which had evaporated during the mixing procedure was determined and replaced. The MDI was now added, the reaction mixture was stirred at 3000 rpm by means of the stirrer described for 5 seconds at 3000 rpm and immediately transferred to a 50 cm×25 cm×5 cm aluminum mold which was lined with polyethylene film and was thermostated at 50° C. The amount of foam formulation used was measured so that it was 10% above the amount necessary for minimum filling of the mold.

One day after foaming, the foams were analyzed. Surface and internal defects were assessed subjectively on a scale from 1 to 10, with 10 representing a foam with no defects and 1 representing an extremely defective foam. The pore structure (mean number of cells per 1 cm) was assessed visually on a cut surface by comparison with comparative foams. The thermal conductivity was measured on 2.5 cm thick disks using a Hesto A Control instrument at temperatures on the underside and upper side of the sample of 10° C. and 36° C. The percentage by volume of closed cells was determined using an AccuPyc 1330 instrument from Micromeritics. The compressive strengths of the foams were measured on cube-shaped test specimens having an edge length of 5 cm in accordance with DIN 53421 to a compression of 10% (the figure reported is the maximum compressive strength occurring in this measuring range). A number of test specimens were in each case loaded in the rise direction of the foam. The burning behavior of the foams was examined in an appropriate small burner test based on DIN 4102. The figure reported is in each case the maximum flame height which was observed within 15 seconds of application of the flame, determined over a plurality of test specimens.

All foam stabilizers used are shown in Tables 2a and 2b.

TABLE 2a
Stabilizers according to the invention
Structure:
R—Si(CH₃)₂—O—[—Si(CH₃)₂—O—]ₙ—[—Si(CH₃)R—O—]ₘ—Si(CH₃)₂—R
R = —(CH₂)₃—O—(CH₂—CHR′—O)_{y}—H

| Designation | Structural parameters |
|---|---|
| PES I | n = 16, m = 2, y = 13, R′ = H (92%), CH₃ (8%) |
| PES II | n = 21, m = 2, y = 13, R′ = H (92%), CH₃ (8%) |
| PES III | n = 22, m = 1, y = 13, R′ = H (82%), CH₃ (18%) |

TABLE 2b
Stabilizers which are not according to the
invention (comparative examples)
Structure:
Si(CH₃)₃—O—[—Si(CH₃)₂—O—]ₙ—[—Si(CH₃)R—O—]ₘ—Si(CH₃)₃
R = —(CH₂)₃—O—(CH₂—CHR′—O)_{y}—H

| Designation | Structural parameters |
|---|---|
| PES IV | n = 20, m = 3, y = 13, R′ = H (82%), |
| | CH₃ (18%) |
| Tegostab ® B 8450* | |
| Tegostab ® B 8462 | |
| Tegostab ® B 8474 | |
| Tegostab ® B 8486 | |
| Tegostab ® B 8512 | |
| Tegostab ® B 8513 | |
| Tegostab ® B 8522 | |
| Tegostab ® B 8871 | |
| DC 193 from Air | |
| Products | |

*Tegostab is a trademark of Goldschmidt GmbH

### 1. Rigid PUR Foam Systems of Burning Class B2 for Metal Composite Elements

Three different formulations matched to this application were used (see Table 3).

TABLE 3
Formulations for Example 1

| Component | Formulation A | Formulation B | Formulation C |
|---|---|---|---|
| Polyether | Blend A | Blend B | Blend C |
| polyol | 75 Parts | 85 Parts | 70 Parts |
| DMPP | 25 Parts | | |
| TCPP | | 15 Parts | 30 Parts |
| PMDETA | 0.2 Part | — | 0.2 Part |
| DMCHA | 1.5 Parts | 2.0 Parts | 2.0 Parts |
| Water | 0.7 Part | 2.5 Parts | 1.0 Part |
| n-Pentane | 7.0 Parts | — | 6.0 Parts |
| Stabilizer | 2.0 Parts | 2.0 Parts | 2.0 Parts |
| MDI* | 150 Parts | 180 Parts | 140 Parts |

*polymeric MDI, 200 mPa * s, 31.5% NCO, functionality = 2.7

The results are shown in Table 4.

State of the art is having low flame height (good burning properties) but lambda value is bad or vice-versa. Flame height should be less than 150 according to a test (make sure this

23.3 and 23.9 is a big difference. Above 23.5 is bad.

TABLE 4
Results for Example 1

| | | | | | | | |
|---|---|---|---|---|---|---|---|
| | | | | | | | Flame |
| | | | | Proportion | | | height |
| | Defects | | | of closed | Compressive | Density | (DIN |
| | top/bottom/ | Cells/ | λ Value | cells | strength | [kg/m³] | 4102) |
| Stabilizer | interior | cm | [mW/m * K] | [%] | [kPa] | total/core | [mm] |

Formulation A

| | | | | | | | |
|---|---|---|---|---|---|---|---|
| B 8512 | 7/9/9 | 36-40 | 23.3 | 94.1 | 150 | 42.0/ | 180 |
| | | | | | | 37.5 | |
| B 8522 | 5/9/7 | 36-40 | 23.4 | 94.0 | 170 | 42.5/ | 175 |
| | | | | | | 37.6 | |
| B 8450 | 6/8/7 | 32-36 | 23.9 | 95.0 | 175 | 42.6/ | 135 |
| | | | | | | 37.4 | |
| B 8486 | 6/9/8 | 36-40 | 23.7 | 95.1 | 190 | 41.9/ | 135 |
| | | | | | | 37.7 | |
| DC 193 | 6/9/8 | 36-40 | 23.8 | 94.7 | 190 | 42.2/ | 135 |
| | | | | | | 37.1 | |
| PES I | 7/9/8 | 36-40 | 23.5 | 94.0 | 195 | 42.3/ | 130 |
| | | | | | | 38.1 | |
| PES II | 7/9/8 | 36-40 | 23.4 | 94.7 | 160 | 42.2/ | 135 |
| | | | | | | 37.4 | |

Formulation B

| | | | | | | | |
|---|---|---|---|---|---|---|---|
| B 8450 | 7/8/6 | 32-36 | 25.7 | 90.7 | 205 | 42.2/ | 120 |
| | | | | | | 37.4 | |
| B 8486 | 6/8/7 | 32-36 | 25.0 | 92.3 | 210 | 42.0/ | 115 |
| | | | | | | 37.0 | |
| DC 193 | 6/8/7 | 32-36 | 25.6 | 91.6 | 215 | 42.5 37.4 | 115 |
| PES I | 6/8/7 | 32-36 | 24.9 | 91.0 | 215 | 42.2/ | 105 |
| | | | | | | 37.2 | |
| PES II | 7/9/7 | 32-36 | 24.6 | 92.2 | 185 | 42.7/ | 105 |
| | | | | | | 37.6 | |

Formulation C

| | | | | | | | |
|---|---|---|---|---|---|---|---|
| B 8450 | 7/8/7 | 36-40 | 23.5 | 91.8 | 185 | 42.8/ | 145 |
| | | | | | | 38.3 | |
| B 8486 | 7/9/7 | 40-44 | 22.9 | 92.7 | 170 | 43.2/ | 150 |
| | | | | | | 38.9 | |
| DC 193 | 7/9/7 | 40-44 | 23.2 | 91.7 | 175 | 42.9/ | 150 |
| | | | | | | 38.1 | |
| PES I | 8/9/7 | 40-44 | 22.7 | 93.4 | 185 | 42.5/ | 150 |
| | | | | | | 38.5 | |
| PES II | 8/9/7 | 44-48 | 22.2 | 93.0 | 180 | 42.8/ | 150 |
| | | | | | | 38.6 | |

The data for formulation A show that although conventional highly active stabilizers such as TEGOSTAB B 8512 and TEGOSTAB B 8522 offer slight advantages in terms of thermal conductivity, they perform very poorly in the burning test. Classification into burning class B2 is not attained using these stabilizers, or would require modification of the formulation with a tremendous increase in the content of flame retardant. When the stabilizers TEGOSTAB B 8450, TEGOSTAB B 8486 and DC 193 which are not according to the invention and have been optimized in respect of flame protection and the stabilizers PES I and PES II according to the invention are used, the formulation A in all cases achieves classification into burning class B2, with the stabilizers according to the invention offering the most balanced combination of low thermal conductivity and good results in the burning test. The advantages of the stabilizers according to the invention become even clearer in the formulations B and C. The foams produced using stabilizers according to the invention display equally good to better results in the burning test in accordance with DIN 4102 and significantly better thermal conductivities than when products which are not according to the invention and have been optimized in respect of flame protection are used.

A great problem in the production of metal composite elements are foam defects in the form of voids which are formed at the lower interface between metal sheet and foam core in the foaming of surface-coated metal sheets. These defects can show up on the surface of the composite elements and thus give cause for complaint.

According to the generally accepted view, surface coating additives, especially leveling additives and deaerators, are the cause of these surface defects. These surface coating additives diffuse during foaming from the surface of the surface coating into freshly applied PUR formulation and there act as antifoams, so that localized collapse of the foam can occur at the interface between surface coating and PUR foam.

The sensitivity of a foam formulation toward antifoaming contamination depends on their composition, in particular on the foam stabilizer. This sensitivity can most simply be compared by stirring a defined amount of an antifoam into the formulation and assessing the structure of the foam produced therewith.

### 2. Rigid PIR Foam System for Continuously Produced Insulation Boards

Two different formulations matched to this application were used (see Table 5) and were foamed with four foam stabilizers which are not according to the invention and one foam stabilizer according to the invention.

TABLE 5
Formulations for Example 2

| Component | Formulation D | Formulation E |
|---|---|---|
| Polyol | Stepan PS | Invista Terate |
| | 2352 | 3522 |
| | 100 Parts | 100 Parts |
| TCPP | 15 Parts | 10 Parts |
| PMDETA | 0.2 Part | 0.2 Part |
| Potassium octoate | 4.0 Parts | 4.0 Parts |
| (75% in DEG) | | |
| Water | 0.4 Part | 0.4 Part |
| n-Pentane | 20 Parts | 20 Parts |
| Stabilizer | 2.0 Parts | 2.0 Parts |
| MDI* | 200 Parts | 195 Parts |

*polymeric MDI, 200 mPa * s, 31.5% NCO, functionality = 2.7

The results are shown in Table 6.

TABLE 6
Results for Example 2

| | | | | | | | |
|---|---|---|---|---|---|---|---|
| | | | | | | | Flame |
| | | | | Proportion | | | height |
| | Defects | | | of closed | Compressive | Density | (DIN |
| | top/bottom/ | Cells/ | λ Value | cells | strength | [kg/m³] | 4102) |
| Stabilizer | interior | cm | [mW/m * K] | [%] | [kPa] | total/core | [mm] |

Formulation D

| | | | | | | | |
|---|---|---|---|---|---|---|---|
| B 8512 | 6/7/8 | 44-48 | 22.6 | 93.7 | 175 | 38.2/ | 155 |
| | | | | | | 34.8 | |
| B 8513 | 5/7/8 | 44-48 | 22.5 | 96.5 | 140 | 38.6/ | 175 |
| | | | | | | 35.0 | |
| B 8522 | 6/7/9 | 44-48 | 22.8 | 94.5 | 165 | 38.8/ | 155 |
| | | | | | | 34.8 | |
| B 8871 | 6/8/9 | 44-48 | 22.6 | 94.0 | 165 | 38.5/ | 160 |
| | | | | | | 35.1 | |
| PES II | 6/8/9 | 44-48 | 22.6 | 92.9 | 165 | 38.5/ | 145 |
| | | | | | | 35.2 | |

Formulation E

| | | | | | | | |
|---|---|---|---|---|---|---|---|
| B 8512 | 5/5/6 | 44-48 | 23.0 | 93.4 | 135 | 36.7/ | 170 |
| | | | | | | 33.4 | |
| B 8513 | 5/6/5 | 36-40 | 23.7 | 91.0 | 145 | 37.2/ | 190 |
| | | | | | | 33.5 | |
| B 8522 | 5/5/6 | 40-44 | 23.7 | 93.6 | 170 | 37.5/ | 165 |
| | | | | | | 33.4 | |
| B 8871 | 5/5/6 | 40-44 | 23.1 | 94.3 | 165 | 37.0/ | 170 |
| | | | | | | 32.7 | |
| PES II | 6/5/7 | 44-48 | 23.0 | 94.0 | 180 | 37.0/ | 145 |
| | | | | | | 33.2 | |

The data show that the foam stabilizer PES II according to the invention offers the most balanced combination of low thermal conductivity and good results in the burning test.

### 3. Rigid PUR Foam System for Insulation of Refrigeration Appliances

A formulation matched to this application was used (see Table 7) and was foamed with three foam stabilizers which were not according to the invention and one foam stabilizer according to the invention. As a difference from the previous procedure, a high-pressure foaming machine from Cannon which had a FPL-HP 14 mixing head was used in this case (mixing chamber pressure=138 bar, throughput 20 kg/min). The formulation was introduced into a 200 cm×20 cm×5 cm aluminum mold thermostated to 45° C. by means of this foaming machine. The amount of foam formulation used was measured so that it was 10% above the amount necessary for minimum filling of the mold.

TABLE 7
Formulation for Example 3

| Component | Formulation F |
|---|---|
| Polyol blend | 100 Parts |
| DMCHA | 3.0 Parts |
| Water | 1.5 Parts |
| HFC 245fa | 33 Parts |
| Stabilizer | 2.5 Parts |
| MDI* | 140 Parts |

*polymeric MDI, 200 mPa * s, 31.5% NCO, functionality = 2.7

The results shown in Table 8 demonstrate that the foam stabilizers according to the invention can not only be employed for flame-resistant rigid foams but can also offer advantages in systems without flame retardant for use as insulation material in refrigeration appliances.

TABLE 8
Results for Example 3

| | | | |
|---|---|---|---|
| | Density at | | |
| | minimum | Defects | |
| | filling | top/bottom/ | λ Value |
| Stabilizer | [kg/m³] | interior | [mW/m * K] |

Formulation F

| | | | |
|---|---|---|---|
| B 8462 | 29.3 | 7/6/7 | 19.9 |
| B 8474 | 30.4 | 7/7/7 | 19.3 |
| PES III | 29.3 | 7/6/7 | 19.0 |
| PES IV | 29.6 | 6/6/6 | 20.4 |

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. A process for producing rigid polyurethane or polyisocyanurate foams by reacting an isocyanate with a polyol in the presence of foam stabilizers, urethane and/or isocyanurate catalysts, water, optionally further blowing agents, optionally flame retardants and optionally further additives, wherein one or more compounds of the general formula (I)
R—Si(CH₃)₂—O—[—Si(CH₃)₂—O—]ₙ—[—Si(CH₃)(R¹)—O—]ₘ—Si(CH₃)₂—R²
where the substituents and indices have the following meanings:
R, R¹, R² are identical or different and are each —(CH₂)ₓ—O—(CH₂—CHR′—O)_{y}—R″,
R′═H, —CH₃, —CH₂CH₃, phenyl,
R″═H, alkyl, acyl,
n+m+2=10 to 45,
m=0 to 4,
x=3 to 10,
y=1 to 19,
are used as foam stabilizers.

2. The process for producing rigid polyurethane or polyisocyanurate foams as claimed in claim 1, wherein at least 50% of the radicals R′ are H.

3. The process for producing rigid polyurethane or polyisocyanurate foams as claimed in claim 1, wherein R″═H.

4. The process for producing rigid polyurethane or polyisocyanurate foams as claimed in claim 1, wherein m=0 to 2.

5. The process for producing rigid polyurethane or polyisocyanurate foams as claimed in claim 1, wherein n+m+2=10 to 40.

6. The process for producing rigid polyurethane or polyisocyanurate foams as claimed in claim 1, wherein x=3 and y=5 to 19.

7. The process for producing rigid polyurethane or polyisocyanurate foams as claimed in claim 1, wherein at least 50% of the radicals R′ are H, R″═H, m=0 to 2, n+m+2=10 to 40, x=3 and y=5 to 19

8. A foam stabilizers compound for producing rigid polyurethane or polyisocyanurate foams which is a compound of the general formula (I)
R—Si(CH₃)₂—O—[—Si(CH₃)₂—O—]ₙ—[—Si(CH₃)(R¹)—O—]ₘ—Si(CH₃)₂—R²
where the substituents and indices have the following meanings:
R, R¹, R² are identical or different and are each —(CH₂)ₓ—O—(CH₂—CHR′—O)_{y}—R″,
R′═H, —CH₃, —CH₂CH₃, phenyl,
R″═H, alkyl, acyl,
n+m+2=10 to 45,
m=0 to 4,
x=3 to 10,
y=1 to 19,
are used as foam stabilizers.

9. The compound as claimed in claim 8, wherein at least 50% of the radicals R′ are H.

10. The compound as claimed in claim 8, wherein R″═H.

11. The compound as claimed in claim 8, wherein m=0 to 2.

12. The compound as claimed in claim 8, wherein n+m+2=10 to 40.

13. The compound as claimed in claim 8, wherein x=3 and y=5 to 19.

14. The compound as claimed in claim 8, wherein at least 50% of the radicals R′ are H, R″═H, m=0 to 2, n+m+2=10 to 40, x=3 and y=5 to 19.

15. A foamable formulation for producing rigid polyurethane or polyisocyanurate foams by reacting an isocyanate with a polyol in the presence of foam stabilizers, urethane and/or isocyanurate catalysts, water, phosphorus-containing flame retardants, optionally further blowing agents and optionally further additives, wherein one or more compounds of claim 8 are used as foam stabilizers.

16. A method for producing flame-resistant rigid polyurethane or polyisocyanurate foam which comprises adding the foamable formulation of claim 15 to a polyurethane or polisocyanurate foam.

17. A method for producing flame-resistant rigid polyurethane or polyisocyanurate foam composite which comprises adding the foamable formulation of claim 15 to a polyurethane or polisocyanurate foam composite.
